(19) United States
(12) Patent Application Publication
(10) Pub. No.: US 2025/0021228 A1
(43) Pub. Date: Jan. 16, 2025

(54) LOCKING HARDWARE FOR A SHARED MEMORY

(71) Applicants: Navneet Singh, Bengaluru (IN); Frank T. Hady, Cannon Beach, OR (US); Andrzej Stasiak, Borkowo (PL); Joseph Jacob Grecco, Saddle Brook, NJ (US)

(72) Inventors: Navneet Singh, Bengaluru (IN); Frank T. Hady, Cannon Beach, OR (US); Andrzej Stasiak, Borkowo (PL); Joseph Jacob Grecco, Saddle Brook, NJ (US)

(21) Appl. No.: 18/900,679

(22) Filed: Sep. 28, 2024

(51) Int. Cl. G06F 3/06

(52) U.S. Cl. CPC G06F 3/0608; G06F 3/0629; G06F 3/067

(57) ABSTRACT

Locking hardware is provided in association with a shared memory. A first lock request is received at the locking hardware from a first host device to lock a portion of the shared memory and a first lock is assigned to the first host device by the locking hardware to provide the first host device exclusive access to the portion of the shared memory. A second request is received from an independent, second host device to lock the portion of the shared memory and is queued by the locking hardware while the first lock is assigned to the first host device. After the first lock is released, the locking hardware assigns a second lock to the second host device based on the second request.

### BACKGROUND

A datacenter may include one or more platforms, where the platforms include at least one processor and associated memory modules. Platforms in the datacenter may facilitate the performance of any suitable number of processes associated with various applications running on the platform. These processes may be performed by the processors and other associated logic of the platforms. Platforms may additionally include I/O controllers, such as network adapter devices, which may be used to send and receive data on a network for use by the various applications.

### BRIEF DESCRIPTION OF THE DRAWINGS

FIG. 1 illustrates a simplified block diagram illustrating example components of a data center.

FIG. 2 illustrates a simplified block diagram of an example computing system utilizing a link compliant with a Compute Express Link (CXL)-based protocol.

FIG. 3 illustrates a simplified block diagram of example protocol circuitry.

FIGS. 4A-4C are simplified block diagram illustrating example CXL device configurations.

FIG. 5 is a simplified block diagram illustrating an example computing system including a shared memory.

FIG. 6 is a simplified block diagram illustrating an example database system implementation utilizing shared memory.

FIG. 7 is a simplified block diagram illustrating example locking hardware associated with a shared system resource.

FIG. 8 illustrates example fields of an example lock request.

FIG. 9 is a simplified block diagram illustrating an example flow of interactions between a software thread and example locking hardware.

FIG. 10 is a simplified block diagram illustrating an example interface of example locking hardware.

FIG. 11 illustrates a block diagram of an example processor device in accordance with certain embodiments.

### DETAILED DESCRIPTION

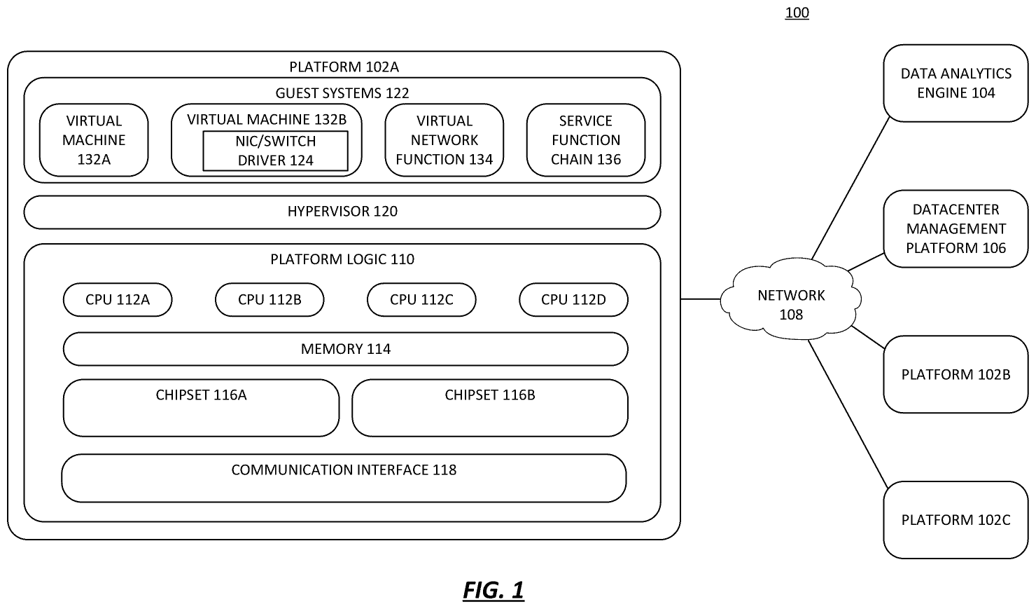

FIG. 1 illustrates a block diagram of components of a datacenter 100 in accordance with certain embodiments. In the embodiment depicted, datacenter 100 includes a plurality of platforms 102, data analytics engine 104, and datacenter management platform 106 coupled together through network 108. A platform 102 may include platform logic 110 with one or more central processing units (CPUs) 112, memories 114 (which may include any number of different modules), chipsets 116, communication interfaces 118, and any other suitable hardware and/or software to execute a hypervisor 120 or other operating system capable of executing processes associated with applications running on platform 102. In some embodiments, a platform 102 may function as a host platform for one or more guest systems 122 that invoke these applications. The platform may be logically or physically subdivided into clusters and these clusters may be enhanced through specialized networking accelerators and the use of Compute Express Link (CXL) memory semantics to make such clusters more efficient, among other example enhancements.

Computing platforms 102 may include platform logic 110. Platform logic 110 comprises, among other logic enabling the functionality of platform 102, one or more CPUs 112, memory 114, one or more chipsets 116, and communication interface 118. Although three platforms are illustrated, datacenter 100 may include any suitable number of platforms. In various embodiments, a platform 102 may reside on a circuit board that is installed in a chassis, rack, compossible servers, disaggregated servers, or other suitable structures that comprises multiple platforms coupled together through network 108 (which may comprise, e.g., a rack or backplane switch).

CPUs 112 may include any suitable number of processor cores. The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removably coupled to platform 102. Although four CPUs are shown, a platform 102 may include any suitable number of CPUs.

Memory 114 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long-term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPUs 112. In some embodiments, memory 114 may also comprise storage for instructions that may be executed by the cores of CPUs 112 or other processing elements (e.g., logic resident on chipsets 116) to provide functionality associated with components of platform logic 110. Additionally or alternatively, chipsets 116 may include memory that may have any of the characteristics described herein with respect to memory 114. Memory 114 may also store the results and/or intermediate results of the various calculations and determinations performed by CPUs 112 or processing elements on chipsets 116. In various embodiments, memory 114 may comprise one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices in memory pools, such as discussed herein. Locking hardware may be provided to implement such shared memory pools, among other technologies.

A platform 102 may also include one or more chipsets 116 comprising any suitable logic to support the operation of the CPUs 112. In various embodiments, chipset 116 may reside on the same package as a CPU 112 or on one or more different packages. A chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via integrated I/O controllers resident on the CPUs.

Chipsets 116 may include one or more communication interfaces 128. Communication interface 128 may be used for the communication of signaling and/or data between chipset 116 and one or more I/O devices, one or more networks 108, and/or one or more devices coupled to network 108 (e.g., datacenter management platform 106 or data analytics engine 104). For example, communication interface 128 may be used to send and receive network traffic such as data packets. In a particular embodiment, communication interface 128 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 116 (e.g., switch 130) and another device coupled to network 108. In some embodiments, network 108 may comprise a switch with bridging and/or routing functions that is external to the platform 102 and operable to couple various I/O controllers (e.g., NICs) distributed throughout the datacenter 100 (e.g., on different platforms) to each other. In various embodiments an I/O controller may be integrated with the chipset (e.g., may be on the same integrated circuit or circuit board as the rest of the chipset logic) or may be on a different integrated circuit or circuit board that is electromechanically coupled to the chipset. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 according to one or more link or interconnect protocols, such as Peripheral Component Interconnect Express (PCIe), CXL, HyperTransport, GenZ, OpenCAPI, NVLink, Advanced Interface Bus (AIB), Infinity Fabric, Open Domain-Specific Architecture (ODSA), Bo-Wave Interconnect, Silicon Interconnect Fabric (Si-IF), Hybrid Bonding Interconnect, Chip-on-Wafer-on-Substrate (CoWoS), Integrated Fan-Out (InFO), Extra Short Reach (XSR) Interconnect, High Bandwidth Interconnect (HBI), among other example interconnect technologies, which may each alternatively or collectively apply the general principles and/or specific features discussed herein. Switch 130 may be a physical or virtual (e.g., software) switch.

Platform logic 110 may include an additional communication interface 118. Similar to communication interface 128, communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 comprises one or more physical I/O controllers (e.g., NICs). These NICs may enable communication between any suitable element of platform logic 110 (e.g., CPUs 112) and another device coupled to network 108 (e.g., elements of other platforms or remote nodes coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112). Further, as discussed herein, I/O controllers may include a power manager to implement power consumption management functionality at the I/O controller (e.g., by automatically implementing power savings at one or more interfaces of the communication interface 118 (e.g., a PCIe interface coupling a NIC to another element of the system), among other example features.

Platform logic 110 may receive and perform any suitable types of processing requests. A processing request may include any request to utilize one or more resources of platform logic 110, such as one or more cores or associated logic. For example, a processing request may comprise a processor core interrupt; a request to instantiate a software component, such as an I/O device driver 124 or virtual machine 132; a request to process a network packet received from a virtual machine 132 or device external to platform 102 (such as a network node coupled to network 108); a request to execute a workload (e.g., process or thread) associated with a virtual machine 132, application running on platform 102, hypervisor 120 or other operating system running on platform 102; or other suitable request.

In various embodiments, processing requests may be associated with guest systems 122. A guest system may comprise a single virtual machine (e.g., virtual machine 132a or 132b) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address, thus allowing multiple virtual machines 132 to be individually addressable in a network.

In some embodiments, a virtual machine 132b may be paravirtualized. For example, the virtual machine 132b may include augmented drivers (e.g., drivers that provide higher performance or have higher bandwidth interfaces to underlying resources or capabilities provided by the hypervisor 120). For example, an augmented driver may have a faster interface to underlying virtual switch for higher network performance as compared to default drivers.

VNF 134 may comprise a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as traditional network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 is group of VNFs 134 organized as a chain to perform a series of operations, such as network packet processing operations. Service function chaining may provide the ability to define an ordered list of network services (e.g., firewalls, load balancers) that are stitched together in the network to create a service chain.

A hypervisor 120 (also known as a virtual machine monitor) may comprise logic to create and run guest systems 122. The hypervisor 120 may present guest operating systems run by virtual machines with a virtual operating platform (e.g., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. A platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform.

Hypervisor 120 may include a virtual switch that may provide virtual switching and/or routing functions to virtual machines of guest systems 122. The virtual switch may comprise a logical switching fabric that couples the vNICs of the virtual machines 132 to each other, thus creating a virtual network through which virtual machines may communicate with each other. Virtual switch may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may comprise a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may include any suitable number of I/O device drivers 124. I/O device driver 124 represents one or more software components that allow the hypervisor 120 to communicate with a physical I/O device. In various embodiments, the underlying physical I/O device may be coupled to any of CPUs 112 and may send data to CPUs 112 and receive data from CPUs 112. The underlying I/O device may utilize any suitable communication protocol, such as PCI, PCIe, Universal Serial Bus (USB), Serial Attached SCSI (SAS), Serial ATA (SATA), InfiniBand, Fibre Channel, an IEEE 802.3 protocol, an IEEE 802.11 protocol, or other current or future signaling protocol.

The underlying I/O device may include one or more ports operable to communicate with cores of the CPUs 112. In one example, the underlying I/O device is a physical NIC or physical switch. For example, in one embodiment, the underlying I/O device of I/O device driver 124 is a NIC of communication interface 118 having multiple ports (e.g., Ethernet ports).

In other embodiments, underlying I/O devices may include any suitable device capable of transferring data to and receiving data from CPUs 112, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various embodiments, when a processing request is received, the I/O device driver 124 or the underlying I/O device may send an interrupt (such as a message signaled interrupt) to any of the cores of the platform logic 110. For example, the I/O device driver 124 may send an interrupt to a core that is selected to perform an operation (e.g., on behalf of a virtual machine 132 or a process of an application). Before the interrupt is delivered to the core, incoming data (e.g., network packets) destined for the core might be cached at the underlying I/O device and/or an I/O block associated with the CPU 112 of the core. In some embodiments, the I/O device driver 124 may configure the underlying I/O device with instructions regarding where to send interrupts.

In some embodiments, as workloads are distributed among the cores, the hypervisor 120 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 132 can be balanced across cores using network load and traffic patterns rather than just CPU and memory utilization metrics.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the datacenter 100 may be coupled together in any suitable manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 122 may communicate with nodes that are external to the datacenter 100 through network 108.

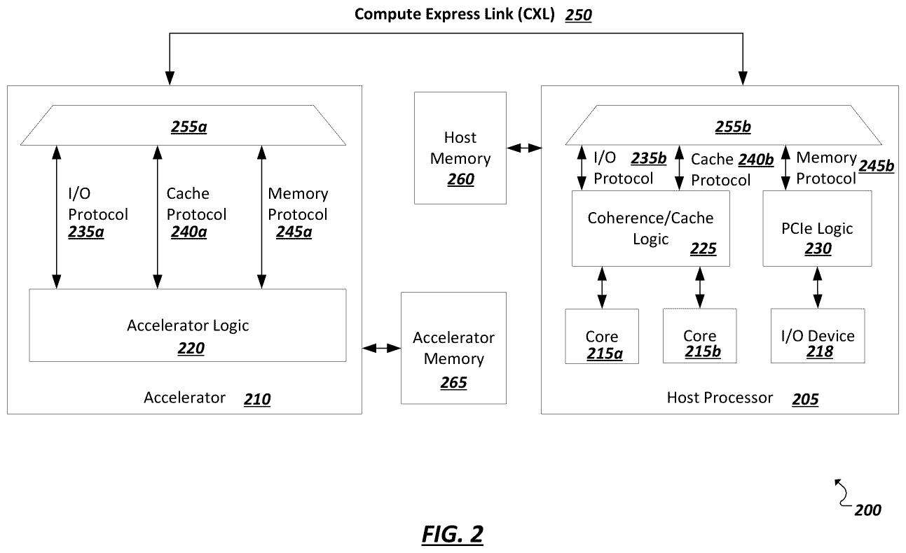

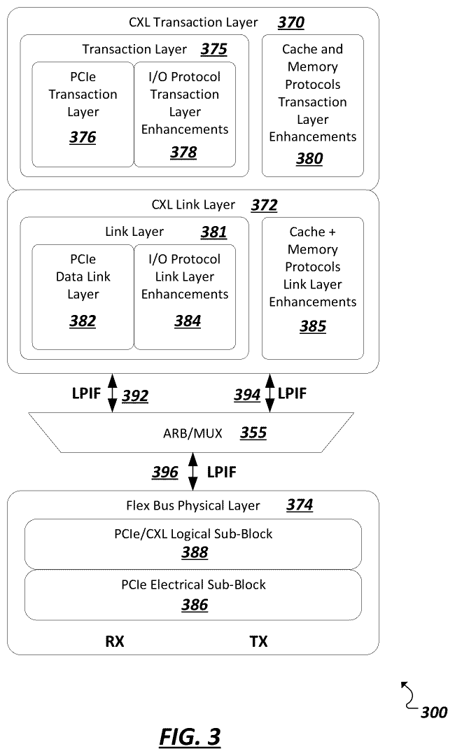

Various interconnect protocols may be utilized to interconnect components within an example datacenter system, including the interconnection of host devices with network interface devices, accelerator hardware, memory devices, and other example components. In some implementations, Compute Express Link (CXL)-based protocols may be utilized to enhance performance of communications between devices coupled point-to-point or within a network. FIGS. 2-3 are simplified block diagrams 200, 300 illustrating example protocol logic, implemented in hardware and/or software, to implement a CXL protocol (e.g., in one or more ports of a device within a system). It should be appreciated, that while much of the discussion centers on features provided by a CXL-protocol and communication channels compliant with CXL, that other substitute protocols with similar, comparable features may be substituted for CXL in the embodiments discussed below. The CXL interconnect protocol is designed to provide an improved, high-speed CPU-to-device and CPU-to-memory interconnect designed to accelerate next-generation data center performance, among other applications. CXL maintains memory coherency between the CPU memory space and memory on attached devices, which allows resource sharing for higher performance, reduced software stack complexity, and lower overall system cost, among other example advantages. CXL enables communication between host processors (e.g., CPUs) and a set of workload accelerators (e.g., graphics processing units (GPUs), field programmable gate array (FPGA) devices, tensor and vector processor units, machine learning accelerators, networking accelerators, purpose-built accelerator solutions, among other examples). Indeed, CXL is designed to provide a standard interface for high-speed communications, as accelerators are increasingly used to complement CPUs in support of emerging computing applications such as artificial intelligence, machine learning, and other applications.

A CXL link may be a low-latency, high-bandwidth discrete or on-package link that supports dynamic protocol multiplexing of coherency, memory access, and input/output (I/O) protocols. Among other applications, a CXL link may enable an accelerator to access system memory as a caching agent and/or host system memory, among other examples. CXL is a dynamic multi-protocol technology designed to support a vast spectrum of accelerators. CXL provides a rich set of sub-protocols that include I/O semantics similar to PCIe (CXL.io), caching protocol semantics (CXL.cache), and memory access semantics (CXL.mem) over a discrete or on-package link. Based on the particular accelerator usage model, all of the CXL protocols or only a subset of the protocols may be enabled. In some implementations, CXL may be built upon the well-established, widely adopted PCIe infrastructure (e.g., PCIe 5.0, PCIe 6.0, etc.), leveraging the PCIe physical and electrical interface to provide advanced protocol in areas include I/O, memory protocol (e.g., allowing a host processor to share memory with an accelerator device), and coherency interface.

Turning to FIG. 2, a simplified block diagram 200 is shown illustrating an example system utilizing a CXL link 250. For instance, the link 250 may interconnect a host processor 305 (e.g., CPU) to an accelerator device 210. In this example, the host processor 205 includes one or more processor cores (e.g., 215a-b) and one or more I/O devices (e.g., 218). Host memory (e.g., 260) may be provided with the host processor (e.g., on the same package or die). The accelerator device 210 may include accelerator logic 220 and, in some implementations, may include its own memory (e.g., accelerator memory 265). In this example, the host processor 205 may include circuitry to implement coherence/cache logic 225 and interconnect logic (e.g., PCIe logic 230). CXL multiplexing logic (e.g., 255a-b) may also be provided to enable multiplexing of CXL protocols (e.g., I/O protocol 235a-b (e.g., CXL.io), caching protocol 240a-b (e.g., CXL.cache), and memory access protocol 245a-b (CXL.mem)), thereby enabling data of any one of the supported protocols (e.g., 235a-b, 240a-b, 245a-b) to be sent, in a multiplexed manner, over the link 250 between host processor 205 and accelerator device 210.

In some implementations, a Flex Bus™ port may be utilized in concert with CXL-compliant links to flexibly adapt a device to interconnect with a wide variety of other devices (e.g., other processor devices, accelerators, switches, memory devices (e.g., near memory, far memory, pooled memory, tiered memory, cache, etc.), among other examples). A Flex Bus port is a flexible high-speed port that is statically configured to support either a PCIe or CXL link (and potentially also links of other protocols and architectures). A Flex Bus port allows designs to choose between providing native PCIe protocol or CXL over a high-bandwidth, off-package link. Selection of the protocol applied at the port may happen during boot time via auto negotiation and be based on the device that is plugged into the slot. Flex Bus uses PCIe electricals, making it compatible with PCIe retimers, and adheres to standard PCIe form factors for an add-in card.

FIG. 3 is a simplified block diagram 300 illustrating an example protocol stack and associated logic (implemented in hardware and/or software) utilized to implement CXL links. For instance, the protocol logic may be organized as multiple layers to implement the multiple protocols supported by the port. For instance, a port may include transaction layer logic (e.g., 370), link layer logic (e.g., 372), and physical layer logic (e.g., 374) (e.g., implemented all or in-part in circuitry). For instance, a transaction (or protocol) layer (e.g., 370) may be subdivided into transaction layer logic 375 that implements a PCIe transaction layer 376 and CXL transaction layer enhancements 378 (for CXL.io) of a base PCIe transaction layer 376, and logic 380 to implement cache (e.g., CXL.cache) and memory (e.g., CXL.mem) protocols for a CXL link. Similarly, link layer logic 372 may be provided to implement a base PCIe data link layer 382 and a CXL link layer (for CXl.io) representing an enhanced version of the PCIe data link layer 384. A CXL link layer 372 may also include cache and memory link layer enhancement logic 385 (e.g., for CXL.cache and CXL.mem).

Continuing with the example of FIG. 3, a CXL link layer logic 372 may interface with CXL arbitration/multiplexing (ARB/MUX) logic 355, which interleaves the traffic from the two logic streams (e.g., PCIe/CXL.io and CXL.cache/CXL.mem), among other example implementations. During link training, the transaction and link layers are configured to operate in either PCIe mode or CXL mode. In some instances, a host CPU may support implementation of either PCIe or CXL mode, while other devices, such as accelerators, may only support CXL mode, among other examples. In some implementations, the port (e.g., a Flex Bus port) may utilize a physical layer 374 based on a PCIe physical layer (e.g., PCI electrical PHY 386). For instance, a Flex Bus physical layer may be implemented as a converged logical physical layer 388 that can operate in either PCIe mode or CXL mode based on results of alternate mode negotiation during the link training process. In some implementations, the physical layer may support multiple signaling rates (e.g., 8 GT/s, 16 GT/s, 32 GT/s, etc.) and multiple link widths (e.g., x16, x8, x4, x2, x1, etc.). In PCIe mode, links implemented by the port may be fully compliant with native PCIe features (e.g., as defined in the PCIe specification), while in CXL mode, the link supports the features defined for CXL. Accordingly, a Flex Bus port may provide a point-to-point interconnect that can transmit native PCIe protocol data or dynamic multi-protocol CXL data to provide I/O, coherency, and memory protocols, over PCIe electricals, among other examples.

The CXL I/O protocol, CXL.io, provides a non-coherent load/store interface for I/O devices. Transaction types, transaction packet formatting, credit-based flow control, virtual channel management, and transaction ordering rules in CXL.io may follow all or a portion of the PCIe definition. CXL cache coherency protocol, CXL.cache, defines the interactions between the device and host as a number of requests that have at least one associated response message and sometimes a data transfer. The interface consists of three channels in each direction: Request, Response, and Data.

The CXL memory protocol, CXL.mem, is a transactional interface between the processor and memory and uses the physical and link layers of CXL when communicating across dies. CXL.mem can be used for multiple different memory attach options including when a memory controller is located in the host CPU, when the memory controller is within an accelerator device, or when the memory controller is moved to a memory buffer chip, among other examples. CXL.mem may be applied to transactions involving different memory types (e.g., volatile, persistent, etc.) and configurations (e.g., flat, hierarchical, etc.), among other example features. In some implementations, a coherency engine of the host processor may interface with memory using CXL.mem requests and responses. In this configuration, the CPU coherency engine is regarded as the CXL.mem Controller and the Mem device is regarded as the CXL.mem Subordinate. The CXL.mem Controller is the agent which is responsible for sourcing CXL.mem requests (e.g., reads, writes, etc.) and a CXL.mem Subordinate is the agent which is responsible for responding to CXL.mem requests (e.g., data, completions, etc.). When the Subordinate is an accelerator, CXL.mem protocol assumes the presence of a device coherency engine (DCOH). This agent is assumed to be responsible for implementing coherency related functions such as snooping of device caches based on CXL.mem commands and update of metadata fields. In implementations, where metadata is supported by device-attached memory, it can be used by the host to implement a coarse snoop filter for CPU sockets, among other example uses.

In some implementations, an interface may be provided to couple circuitry or other logic (e.g., an intellectual property (IP) block or other hardware element) implementing a link layer (e.g., 372) to circuitry or other logic (e.g., an IP block or other hardware element) implementing at least a portion of a physical layer (e.g., 374) of a protocol. For instance, an interface based on a Logical PHY Interface (LPIF) specification to define a common interface between a link layer controller, module, or other logic and a module implementing a logical physical layer (“logical PHY” or “logPHY”) to facilitate interoperability, design and validation re-use between one or more link layers and a physical layer for an interface to a physical interconnect, such as in the example of FIG. 3. Additionally, as in the example of FIG. 3, an interface may be implemented with logic (e.g., 381, 385) to simultaneously implement and support multiple protocols. Further, in such implementations, an arbitration and multiplexer layer (e.g., 355) may be provided between the link layer (e.g., 372) and the physical layer (e.g., 374). In some implementations, each block (e.g., 355, 374, 381, 385) in the multiple protocol implementation may interface with the other block via an independent interface (e.g., 392, 394, 396). In cases where bifurcation is supported, each bifurcated port may likewise have its own independent interface, among other examples.

CXL is a dynamic multi-protocol technology designed to support accelerators and memory devices. CXL.io is for discovery and enumeration, error reporting, peer-to-peer (P2P) access to CXL memory and host physical address (HPA) lookup. CXL.cache and CXL.mem protocols may be implemented by various accelerator or memory device usage models. An important benefit of CXL is that it provides a low-latency, high-bandwidth path for an accelerator to access the system and for the system to access the memory attached to the CXL device. The CXL 2.0 specification enabled additional usage models, including managed hot-plug, security enhancements, persistent memory support, memory error reporting, and telemetry. The CXL 2.0 specification also enables single-level switching support for fan-out as well as the ability to pool devices across multiple virtual hierarchies, including multi-domain support of memory devices. The CXL 2.0 specification also enables these resources (memory or accelerators) to be off-lined from one domain and on-lined into another domain, thereby allowing the resources to be time-multiplexed across different virtual hierarchies, depending on their resource demand. Additionally, the CXL 3.0 specification doubled the bandwidth while enabling still further usage models beyond those introduced in CXL 2.0. For instance, the CXL 3.0 specification provides for PAM-4 signaling, leveraging the PCIe Base Specification PHY along with its CRC and FEC, to double the bandwidth, with provision for an optional flit arrangement for low latency. Multi-level switching is enabled with the CXL 3.0 specification, supporting up to 4K Ports, to enable CXL to evolve as a fabric extending, including non-tree topologies, to the Rack and Pod level. The CXL 3.0 specification enables devices to perform direct peer-to-peer accesses to host-managed device memory (HDM) using Unordered I/O (UIO) (in addition to memory-mapped I/O (MMIO)) to deliver performance at scale. Snoop Filter support can be implemented in Type 2 and Type 3 devices to enable direct peer-to-peer accesses using the back-invalidate channels introduced in CXL.mem. Shared memory support across multiple virtual hierarchies is provided for collaborative processing across multiple virtual hierarchies, among other example features.

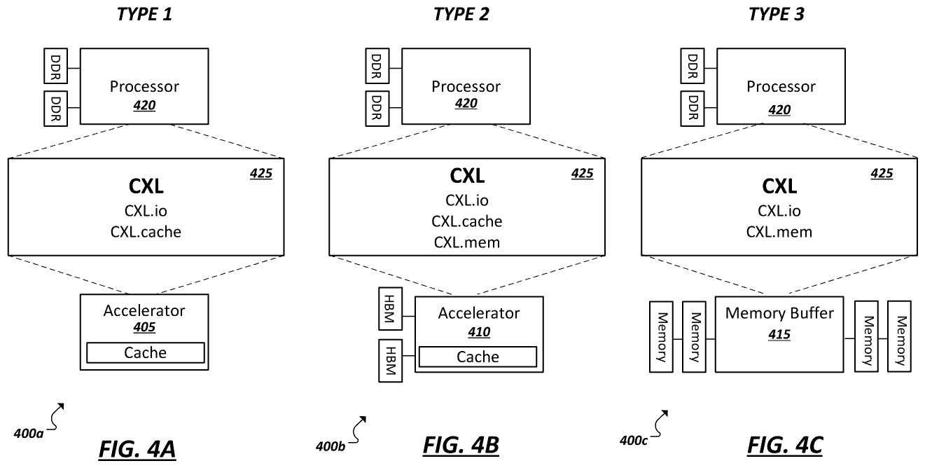

CXL may be used to interconnect peripheral devices that can be either traditional non-coherent I/O devices, memory devices, or accelerators with additional capabilities. When Type 2 and Type 3 device memory is exposed to the host, it is referred to as Host-managed Device Memory (HDM). The coherence management of this memory may be Host-only Coherent (HDM-H), Device Coherent (HDM-D), and Device Coherent using Back-Invalidation Snoop (HDM-DB). The host and device must have a common understanding of the type of HDM for each address region. FIGS. 4A-4C are simplified block diagrams 400a-c showing examples of CXL Type 1 devices (e.g., 405), Type 2 devices (e.g., 410), and Type 3 devices (e.g., 415). A CXL device (e.g., 405, 410, 415) may couple to a host processor (e.g., 420) via a CXL interconnect 425. Different CXL device types may utilize different combinations of the CXL protocols (or sub-protocols) (e.g., CXL.io, CXL.mem, CXL.cache).

In CXL, a “Type 1” devices have special needs for which having a fully coherent cache in the device becomes valuable. For such devices, standard producer-consumer ordering models do not work well. One example of a device with special requirements is to perform complex atomics that are not part of the standard suite of atomic operations present on PCIe. Basic cache coherency allows an accelerator to implement any ordering model it chooses and allows it to implement an unlimited number of atomic operations. These tend to require only a small capacity cache which can easily be tracked by standard processor snoop filter mechanisms. The size of cache that can be supported for such devices depends on the host's snoop filtering capacity. CXL supports such devices using its optional CXL.cache link over which an accelerator can use CXL.cache protocol for cache coherency transactions.

CXL “Type 2” devices, in addition to fully coherent cache, also have memory, for example DDR, High-Bandwidth Memory (HBM), or other memory attached to the device. These devices execute against memory, but their performance comes from having massive bandwidth between the accelerator and device-attached memory. One goal for CXL is to provide a means for the Host to push operands into device-attached memory and for the Host to pull results out of device-attached memory such that it does not add software and hardware cost that offsets the benefit of the accelerator. Systems may include coherent system address-mapped device-attached memory, also referred to as HDM with Device Managed Coherence (HDM-D/HDM-DB). There is an important distinction between HDM and traditional I/O and PCIe Private Device Memory (PDM). An example of such a device is a GPGPU with attached GDDR. Such devices have treated device-attached memory as private. This means that the memory is not accessible to the Host and is not coherent with the remainder of the system. It is managed entirely by the device hardware and driver and is used primarily as intermediate storage for the device with large data sets. A disadvantage to a model such as this is that it involves high-bandwidth copies back and forth from the Host memory to device-attached memory as operands are brought in and results are written back. Please note that CXL does not preclude devices with PDM.

At a high level, there are two example approaches of resolving device coherence of HDM. The first uses CXL.cache to manage coherence of the HDM and is referred to as “Device coherent.” The memory region supporting this flow is indicated with the suffix of “D” (HDM-D). The second approach uses the dedicated channel in CXL.mem called Back Invalidation Snoop and is indicated with the suffix “DB” (HDM-DB). With HDM-DB, the protocol enables new channels in the CXL.mem protocol that allow direct snooping by the device to the host using a dedicated Back-Invalidation Snoop (BISnp) channel. The response channel for these snoops is the Back-Invalidation Response (BIRsp) channel. The channels allow devices the flexibility to manage coherence by using an inclusive snoop filter tracking coherence for individual cache lines that may block new M2S Requests until BISnp messages are processed by the host.

A CXL “Type 3” device supports CXL.io and CXL.mem protocols. An example of a CXL Type 3 Device is a memory expander for the Host. Since this is not a traditional accelerator that operates on host memory, the device does not make any requests over CXL.cache. A passive memory expansion device would use the HDM-H memory region and while not directly manipulating its memory while the memory is exposed to the host. The device operates primarily over CXL.mem to service requests sent from the Host. The CXL.io protocol is used for device discovery, enumeration, error reporting and management. The CXL.io protocol is permitted to be used by the device for other I/O-specific application usages. The CXL architecture is independent of memory technology and allows for a range of memory organization possibilities depending on support implemented in the Host. Type 3 device Memory that is exposed as an HDM-DB enables the device to directly manage coherence with the host to enable in-memory computing and direct access using UIO on CXL.io. A Type 3 Multi-Logical Device (MLD) can partition its resources into up to multiple (e.g., 16) isolated Logical Devices. A Logical Device may be identified by a Logical Device Identifier (LD-ID) in CXL.io and CXL.mem protocols. A Logical Device visible to a Virtual Hierarchy (VH) may operate as a Type 3 device. The LD-ID is transparent to software. MLD components have common Transaction and Link Layers for each protocol across the LDs.

Systems may utilize CXL to maintain memory coherency between the CPU memory space and memory on attached devices, so that any of the CPU cores or any of the other I/O devices configured to support CXL may utilize these attached memories and cache data locally on the same. Further, CXL allows resource sharing for higher performance, such that memory pooling may be achieved across different computing entities. Such CXL-enabled memory pools may enable enhanced and more efficient movement of operands. For instance, rather than utilizing DMA operation to transfer an entire segment of data from one computing element to the next computing element in association with a corresponding operation, coherent memory allows data to be moved seamlessly as if it were a simple transfer between the different cores in different CPU sockets. Such memory pooling can thus realize significant latency reduction and enable this aggregated memory in the system. Such features can enable more efficient memory usage, reduced architectural complexity, and thereby lower overall system costs. Further, such features allow programmers and system developers to focus on target workloads as opposed to redundant memory management, among other example benefits.

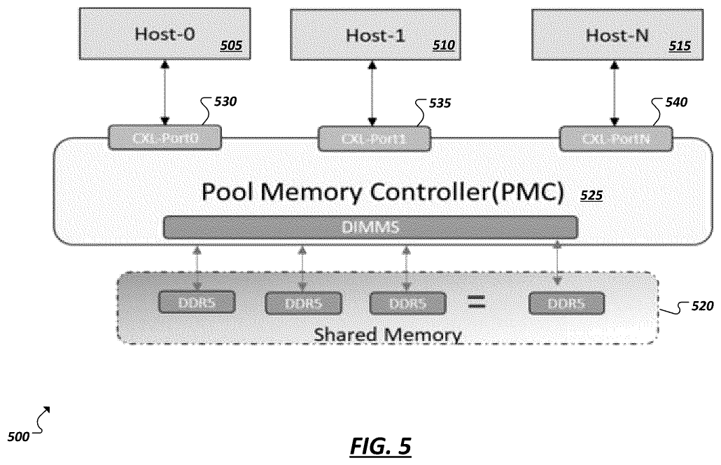

Memory is one of the most expensive components of the modern datacenter platform. Accordingly, increasing utilization of memory capacity may lead directly to reductions in costs. Memory pooling is an emerging technology in some implementations to reduce the total cost of ownership (TCO) for cloud service providers (CSP) by better utilization of memory across nodes (or hosts). CXL may be utilized to implement some memory pooling solutions. However, the coherency and memory protocols of CXL and other existing protocols may fall short in efficiently and effectively implementing memory sharing and memory pools between multiple independent host processors or compute nodes. For instance, turning to the simplified block diagram 500 of FIG. 5, a set of multiple host devices 505, 510, 515 are shown, which share access to a shared memory 520 (or another shared datacenter resource (e.g., networking resource, processing resources, etc.)). The shared memory may be accessed, in one example implementation, by the host device 505, 510, 515 through a memory controller device 525. The host devices 505, 510, 515 may be separate processor devices capable of each running a separate independent operating system. The memory elements implementing the share memory may be remote from the host devices 505, 510, 515 (although in some implementations the memory may be attached to one of the host devices) and access the share memory and/or memory controller over one or more networks, among other example implementations. The memory controller device 525 may include multiple ports (e.g., 530, 535, 540) to couple to the multiple host devices 505, 510, 515 (e.g., using respective interconnect links (e.g., based on PCIe, CXL, or links of another interconnect protocol)).

Locks and mutexes are used to facilitate concurrent programming (e.g., multithreaded, parallel computing, etc.) and enabling concurrency control, data consistency (e.g., critical region protection) and thread synchronization, among other examples. While concurrency protocols may be utilized to implement concurrency between processes or threads running on a single host, such protocols may be incapable of maintaining concurrency between independent hosts (e.g., hosts running independent operating systems, with independent drivers (used for accessing the shared memory) and having independent coherency domains). For instance, independent hosts may omit any direct coordination between each other in association with accessing shared memory shared between the independent hosts, including no direct communication (e.g., sideband communication) between their respective drivers, with each host solely responsible for its own coherency domain. For instance, to implement sharing of a single memory (e.g., 520) (e.g., CXL memory) amongst multiple processes on independent hosts (as may be utilized in some data centers) may necessitate the use of a separate synchronization mechanism between the hosts sharing the resource. Further, traditional mutexes and locks may also be incapable of functioning across process, OS, and node boundaries to the shared resource (e.g., shared memory resource 520). Furthermore, some traditional, software-based mutexes and locks may rely on software-based polling that may be inefficient and costly at scale (e.g., due to the processing resources consumed to implement the polling), among other example issues.

In some implementations, locking hardware is provided (e.g., in memory controller device 525) to implement a mutex in hardware to enable the sharing of another hardware resource, such as a shared memory device, between multiple independent host devices. The locking hardware may implement an efficient, low power, low latency mutex, which may be utilized in a variety of applications. For instance, the hardware-implemented mutex may be used to protect corruption of critical data regions or otherwise protect data in shared memory from being used while being modified. For instance, a software application modifying the data may first attempt to acquire a mutex for given block, range, or other portion of the shared memory and thereby prevent other hosts from being allowed to access and use the memory. If the application acquires the mutex lock, the application is then safe to start modifying or otherwise accessing the data. Any other participant wishing to use a particular range of shared memory, the participant (e.g., an application, service, thread, process, etc.) may be first required to acquire a corresponding mutex implemented using the locking hardware. If the mutex has already been acquired, the requesting thread (or other participant) may be simply denied or parked waiting for the lock to become available. Within this context, to be “parked” involves the participant being placed in a pending or waiting state while blocked waiting for a corresponding mutex (or other synchronization object) for a given range of data to become available. In the case of a critical region, the amount of time a thread may spend in a parked state may be assumed to be relatively short, as the participant holding the lock may keep the lock only while it is modifying the data.

Such locks, mutexes, and synchronization objects may be deployed in other contexts as well, such as to implement counting semaphores (e.g., in a consumer/producer use case where the consumer thread parks on a counting semaphore until a producer provides the resource (e.g., with the consumer possibly parked for an indefinite amount of time while the count is zero) or doorbells (e.g., where the consumer waits to be notified that there is some work to be done by parking on a locked mutex), among other examples.

In the case of a critical region, the amount of time a thread may spend in a parked state may be assumed to be relatively short, as the participant holding the lock may keep the lock only while it is modifying the data. Such locks, mutexes, and synchronization objects may be deployed in other contexts as well, such as to implement counting semaphores (e.g., in a consumer/producer use case where the consumer thread parks on a counting semaphore until a producer provides the resource (e.g., with the consumer possibly parked for an indefinite amount of time while the count is zero) or doorbells (e.g., where the consumer waits to be notified that there is some work to be done by parking on a locked mutex), among other examples. In both the case of counting semaphore and doorbells, the corresponding participant, consumer, thread, etc. may potentially be parked for long periods of time, which may be expensive to implement using traditional approaches, which include software polling. However, the locking hardware discussed herein may manage low latency switching from parked to unparked states (e.g., time from being signal to thread return) and is also power efficient while participants are in the parked state. Further, where there is no suitable support for atomicity or otherwise handling across independent notes, the locking hardware may provide concurrent access to the shared memory, among other example features and use cases.

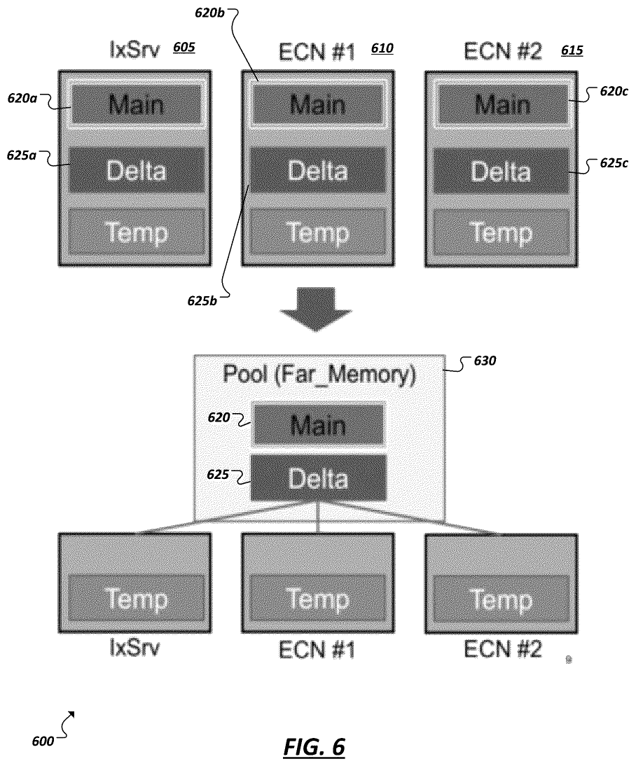

In some examples, synchronization may be a requirement to update shared data from concurrent accesses by multiple servers (e.g., independent hosts or nodes (running different OS instances) on multiple servers). As an illustrative example, FIG. 6 shows a simplified block diagram 600 illustrating an example database system implemented, for instance, as an In Memory Database Management Systems (IMDBMS). In this example, a set of compute nodes (e.g., 605, 610, 615, etc.) has a respective copy of a main database, or table data (e.g., 620a-c) as well as respective delta storage (e.g., 625a-c). In one example, the columnar data of the database(s) may be stored in a read-optimized main storage and a separate delta storage may be maintained for optimized writes. The delta storage may be periodically merged with the main storage. In one example, locking hardware may be utilized within such a system to implement memory sharing (e.g., similar to the example implementation of FIG. 5) to allow advantageously move table data (e.g., 620) and delta storage (e.g., 625) into a shared memory system 630 (e.g., a CXL-based memory device implementing a shared memory pool) to avoid data replication typical in traditional systems. Without the locking hardware, providing shared access by multiple compute nodes 605, 610, 615 (e.g., (ECN) or (IxSrv)) can result in concurrent attempts to read and write to the database which can lead to race condition and/or corrupt the database. In such instances, if compute nodes (e.g., 605, 610, 615) are independent with independent coherency domains, there may be no synchronization mechanism to guarantee the concurrency of the data in the shared memory resource(s) implementing the database, among other example issues.

As introduced, locking hardware may be provided in association with a shared memory resource, such as hardware implemented on the same die or package as the shared memory resource, a memory management device, system on chip (SoC), system in package (SiP), or another implementation. The locking hardware may provide hardware-implemented lock mechanism for non-coherent hosts cooperating within or otherwise concurrently accessing a block of shared memory on the memory resource (e.g., a shared CXL memory device). The lock may be programmatically defined to protect one or more specific blocks (e.g., physical address memory ranges) on the memory resource. Accesses by various independent hosts may be authenticated or identified based on a secure key provided by the host requesting a lock from the locking hardware. In the case of CXL memory, CXL attached non-coherent clients (e.g., implemented on independent hosts) can safely exchange information about CXL memory protected sections. Where multiple lock requests compete to lock a respective portion (e.g., block, entry, memory range, etc.) of the shared memory protected by the locking hardware, later arriving lock requests may be enqueued by the locking hardware and corresponding software (e.g., the requesting host's OS, the client software, etc.) may be notified about the lock acquisition by hardware (e.g., through user interrupts). Example locking hardware may be included and activated to enable workloads to run concurrently on different nodes to efficiently share memory and thereby reduce the need to copy the data over one or more networks. This may further enable a race-free mechanism for coordinating access workloads on nodes in non-coherent systems that does not resort to relying on inefficient, software-based polling used in traditional systems.

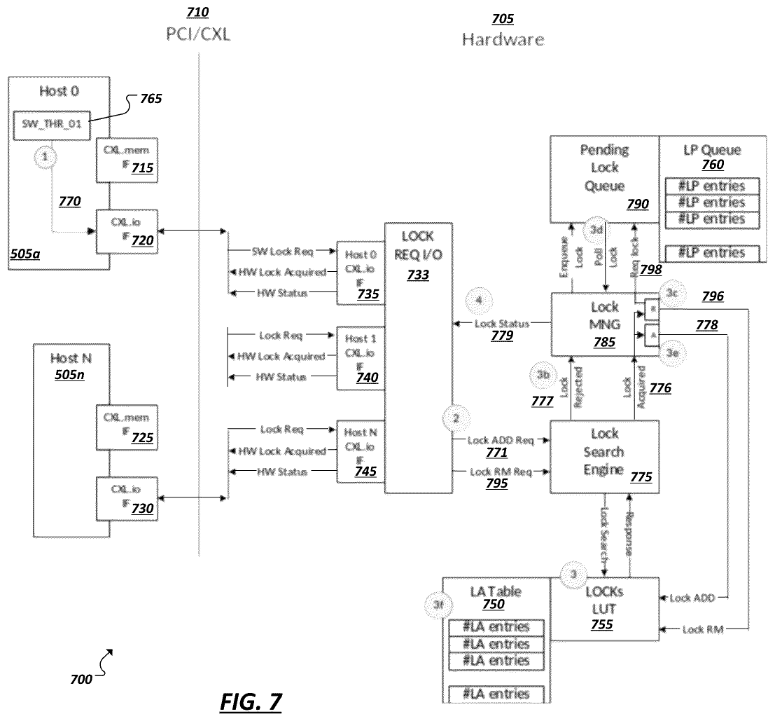

Turning to the simplified block diagram 700 at FIG. 7, an example implementation of locking hardware 705 is shown, which may couple to multiple host devices (e.g., 505a-n) to assist in controlling the hosts' access to a range of shared memory implemented on one or more memory devices (e.g., implementing a shared memory pool, a shared database system (such as in the example of FIG. 6), among other examples). The locking hardware 705 may implement a hardware function enabling hosts 505a-n to efficiently manage a mutex for distributed, non-coherent requests over an interconnect 710 (e.g., a CXL-based interconnect).

Host devices (e.g., 505a-n) may include interfaces (e.g., 715, 720, 725, 730) compatible with a protocol of the interconnect 710 to send requests to the locking hardware 705 to acquire locks to various portions of memory in shared memory ranges managed using the locking hardware. In this example, a CXL.io protocol may be utilized for the sending of lock requests. Likewise, an I/O block 733 of the locking hardware 705 may include multiple interfaces (e.g., 735, 740, 745, etc.) to couple the locking hardware 705 to the multiple host devices 505a-n. In other implementations, a single interface of the locking hardware 705 may couple to a switch to effectively couple the locking hardware 705 to multiple different hosts, among other example implementations, Granted locks may be maintained in a lock acquired (LA) table 750 of the locking hardware 705. When a lock has already been granted to or acquired by a respective client, if a competing lock request is received (e.g., from a thread executed on another one of the independent host devices) for the same portion of memory, the locking hardware 705 may identify this (e.g., using a look up table (LUT) 755 based on the LA table 750 and, rather than immediately granting the lock request, instead enqueuing the competing lock request (in lock pending (LP) queue 760) and responding to the competing request, in some implementations, by providing an indication to the requester that the lock request has been queued.

In one example implementations, chunks or ranges of shared memory may be allocated or assigned to the various host devices (e.g., as a CXL3.0 Dynamic Capacity Device (DCD)) as a shared extents, and the host devices may maintain the associated physical address(es) and size of the shared memory, with corresponding kernel drivers (e.g., CXL kernel drivers) loaded in the host adding that extent in its respective system address space. A host software thread (e.g., 765) may identify that a transaction or workload of the thread involves reading and/or writing data to a particular address and may identify that this particular address corresponds to the shared memory managed using the locking hardware 705. Accordingly, as part of its attempt to access the data at this particular address, the thread (or corresponding software of the host (e.g., a driver, the OS, etc.) may determine that a mutex or other lock should be requested for the particular address. Accordingly, a lock request 770 may be sent from the host device 505a over the interconnect 710 to the locking hardware 705. The I/O block 733 may decode received requests to determine if the request is a request to add a new lock or a request to remove or relinquish an existing, previously acquired lock and may be routed (e.g., at 771 for lock acquisition requests or at 795 for lock removal requests) to a lock search engine block 775. The lock search engine block 775 of the locking hardware 705 may consult the LUT 755 to determine if a competing lock already exists (e.g., a lock for the same or an overlapping portion of the shared memory requested in the lock request 770).

Continuing with the example of FIG. 7, the lock search engine 775 may identify, from the request 770 (and/or signal 771) the requested address range lock (e.g., device physical address (DPA) HI, DPA LOW) with currently active locks, and if a hit or overlap is identified with existing locks, the lock search engine 775 may return a lock rejected 777 signal to a lock manager block 785, which may cause a pending lock queue manager block 790 to create a new entry in the LP queue 760. Lock requests may overlap, even where the lock requests identify and pertain to different address ranges in the shared memory, so long as at least a portion of the shared memory is included in both lock requests (e.g., the two address ranges overlap). Requests may be queued according to a first-in-first-out algorithm (or other algorithm (e.g., an algorithm which also considers service levels or quality of service agreements with corresponding hosts, applications, or threads, etc.)) for the shared memory portion in the LP queue 760. If, on the other hand, the lock search engine 775 determines that no existing locks exist for the requested shared memory portion, the lock search engine 775 may return a lock acquired 776 signal to the lock manager block 785, causing the lock manager 785 to add (at 778) the new lock to the LA table 750. The lock manager 785 may output a lock status signal 779 to cause a corresponding message or signal to be sent to the requesting thread (e.g., 765) over interconnect 710 that the request 770 resulted in the acquisition of a new lock or a rejection (e.g., a queued lock request). In the event the requested lock is granted, the thread 765 may then be permitted, as long as it holds the lock, to have exclusive access to the corresponding portion of shared memory and safely complete the transaction(s) (e.g., reads and/or writes) into the locked portion of shared memory.

When a client has completed its transaction(s) involving a portion of the shared memory for which it has acquired a lock from the locking hardware 705, the client (e.g., thread 765) may send a request to release or return the lock to the locking hardware 705. The locking hardware 705 may receive and decode the request and identify to the lock manager 785 that a lock release request for a given lock, corresponding to a given portion of the shared memory, is being returned. The lock manager 785 may validate or authenticate the lock release request (e.g., based on a token or key included in the request) and may cause (at 796) the lock to be released and removed from the LA table. If the validation fails (e.g., the key provided in the release request does not match the key for the lock as maintained in the LA table 750), a release failed message may be returned to the requester from the locking hardware to the requesting client over the interconnect 719. If the lock request is validated and the corresponding lock released, the lock manager 785 may signal (at 798) the pending lock queue manager 790 to request that any competing lock pending requests (e.g., for the same or overlapping portion(s) of memory corresponding to the released lock) be polled, or released from the LP queue 760, causing a new lock for a portion of the shared memory defined in the associated LP queue entry to be created and pushed to the LA table 750 (and LUT 755). The source (e.g., client on host device 505n) of the newly granted (and formerly pending) lock request may be notified (e.g., via an interrupt corresponding to lock status signal 779) that it now holds a lock for the requested portion of the shared memory, allowing this client to access the corresponding portion of shared memory, and so on. In some implementations, messages sent from the locking hardware 705 in response to lock requests (for acquisition or release of locks) may be based on the protocol of the interconnect 170 (e.g., CXL-based messages (e.g., CXL.io)), among other examples.

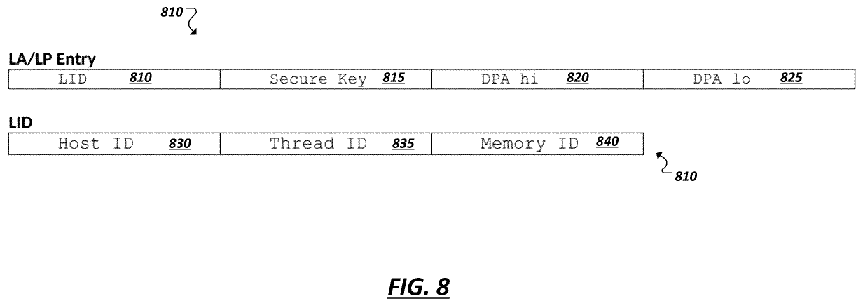

Turning to FIG. 8, a representation 805 of an example entry in a LA table and/or LP table of example locking hardware is shown. In this example, the LA/LP table entry 805 may include a lock or lock request identifier (LID) 810, a secure key (e.g., Secure Shell (SSH), AES-256, etc.) or other token value (e.g., 815), and an identification of the portion of shared memory to which the lock request (e.g., acquisition or release) applies. For instance, beginning and end address values (e.g., DPA hi 820 add DPA lo 825) may be provided in the request 805 for the range of the request portion of the shared memory. A secure key value 815 may be generated by the requesting host for inclusion in the request. Other fields may also be provided in requests, such as header values (e.g., corresponding to the interconnect protocol used to send the request), a type field (e.g., to identify whether the request is a request to acquire a new lock, a request to release an acquired lock, a request to rescind a queued request to acquire a lock, etc.), among other examples. As there may be several lock requestors among the multiple independent hosts sharing a particular memory resource, as well as the potential multiple clients executed on the different non-coherent hosts and for threads within each client, etc. Each client sends lock requests with a unique LID 810. For instance, FIG. 8 also includes a representation 810 of an example implementation of such an LID. In one example, the LID 810 may include a host ID 830 (e.g., a unique identifier corresponding to the requesting host (e.g., as provided by a corresponding user-mode (UMD) driver), a thread ID 835 corresponding to the requesting thread (e.g. provided by the UMD driver), and a memory ID 840 enumerated and managed by the thread originator (e.g., per requested memory range lock), among other examples. These various fields may be used by the requester and/or locking hardware to facilitate the handling of corresponding lock acquisition and release requests, as well as the queueing or pending requests, among other examples uses.

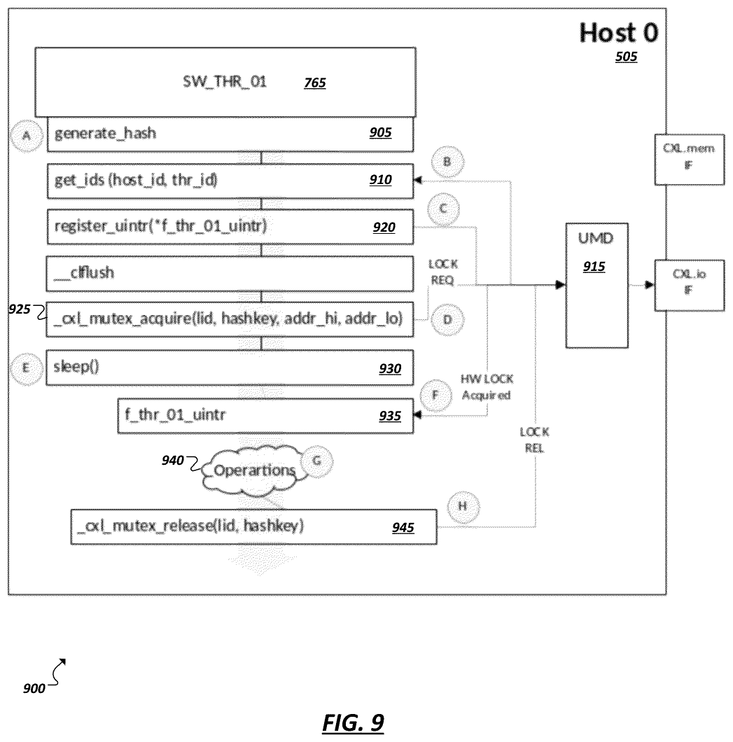

Turning to FIG. 9, a simplified block diagram 900 is shown of an example implementation of a software process (e.g., a client thread, driver process, etc.) used to identify and request locks from example locking hardware. For instance, an example software thread may attempt to acquire and set the lock for its non-coherent domain using a hardware assisted lock function (provided through the locking hardware). For instance, a requesting software thread (e.g., 765) may generate 905 a secure key or hash (SEC_KEY). In some implementations, the generation of the SEC_KEY may be done a single time for the thread instance and reused in its various lock requests. In other instances, the SEC_KEY may be generated at a different cadence, such as per transaction, according to an expiration clock for the hash, etc. The SEC_KEY may be used to identify a lock owner, such as the specific thread (e.g., 765) that requests and acquires a lock. The thread 765 may acquire additional information for use in its lock requests, such as identifiers 910 for use in the lock request (e.g., by requesting a host ID and thread ID from its host's UMD driver 915). In one example, the UMD driver 915 is responsible for generating these unique IDs, as well as performing other supportive functions corresponding to a lock, such as enqueuing received requests, managing/tracking lock request status, communicating with the locking hardware (e.g., by sending received requests over MMIO), generating interrupts, among other examples. The requesting thread may further register 920 a “user interrupt” (uINTR) service call back function (for use with interrupts to be generated in association with its lock request(s), and may send 925 the lock request (e.g., based on a corresponding interconnect protocol (e.g., in the case of CXL, through a_CXL_MUTEX_ACQUIRE( ) call, among other examples. In some implementations, the thread may be placed into a sleep state 930 while waiting for lock acquisition. When the locking hardware function grants the lock (e.g., immediately in response to the lock request or after initially placing the lock request within a pending queue), the uINTR may be sent 935 placed into a kernel runlist. The software thread may then continue its operations 940 while holding the now granted LOCK. Once it finishes its operations, the thread 765 may release the LOCK by sending 945 a release request (e.g., according to an interconnect protocol (e.g., in the case of CXL, a_CXL_MUTEX_RELEASE( ) call, among other examples)).

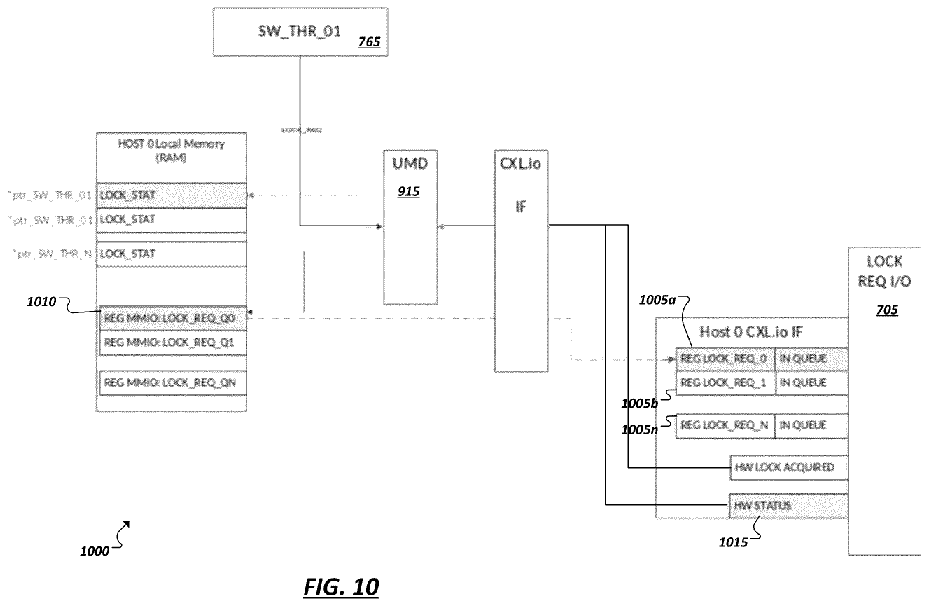

Communication between a software client on a host device may be facilitated through a driver (e.g., a UMD driver). In some implementations, communication between a driver and the locking hardware may be facilitated through memory-mapped-I/O (MMIO) registers or other structures, with requests sent from a host to the locking hardware through register entries. For instance, turning to the simplified block diagram 1000 of FIG. 10, an interface of the locking hardware may be implemented, at least in part, through a set of lock request registers (e.g., 1005a-n). The registers may be exposed to various host systems coupled to the locking hardware by an interconnect, and hosts may send their requests to the locking hardware using the exposed registers 100a-n. For instance, a respective number of exposed hardware registers (REG_MMIO_LOCK_REQ_N) may be mapped to respective hosts, for instance, to achieve load balancing between the hosts (e.g., with the same or different numbers of registers allocated to respective hosts coupled to the locking hardware via the interconnect). For instance, the enumeration and assignments of registers to hosts may be based on a service-level policy, a first come-first served policy, or other factors or algorithms. In the example of FIG. 10, a host 505 may track locks which have been acquired by processes or threads executed on the host, as well as write lock requests to its MMIO registers (e.g., 1010) to convey requests to the exposed registers 1005a-n of the locking hardware 705 mapped to the host. Further, respective software threads 765 at a given host may be equipped with a status cache line (PTR_SW_THR_01) allocated in host memory to track the status of requests to the locking hardware. For instance, the cache line (e.g., 1015) may be used to convey status information from the locking hardware relating to its operation status back to the corresponding requesting software thread (e.g., 765) of the host. For instance, respective cache lines of the threads may be allocated and addresses provided for corresponding software threads by the software driver (e.g., 915), among other example implementations.

In some implementations, software that is to utilize a locking hardware device may initiate requests and receive notifications via a defined application programming interface (API) accessible to software programs that are to use data in the shared or pooled memory managed using the locking hardware. For instance, an API may be used to allow an application to query if a memory pool is available or if asynchronous memory pool request fulfilling (e.g., through corresponding locking hardware) is supported. The API may be used to query if a memory pool supports queued access requests. An API may be used to provide requests for access to the memory pool (including the provision of corresponding security keys). The API may be further utilized to receive a response to requests to access (and obtain a lock) to a particular block of shared memory. In some implementations, a call back function or interrupt vector may be provided by a host through the API to be called when a queued request has been fulfilled. Defined API calls and responses may be provided for the various features and exchanges between a host and locking hardware, such as discussed above, among other example features.

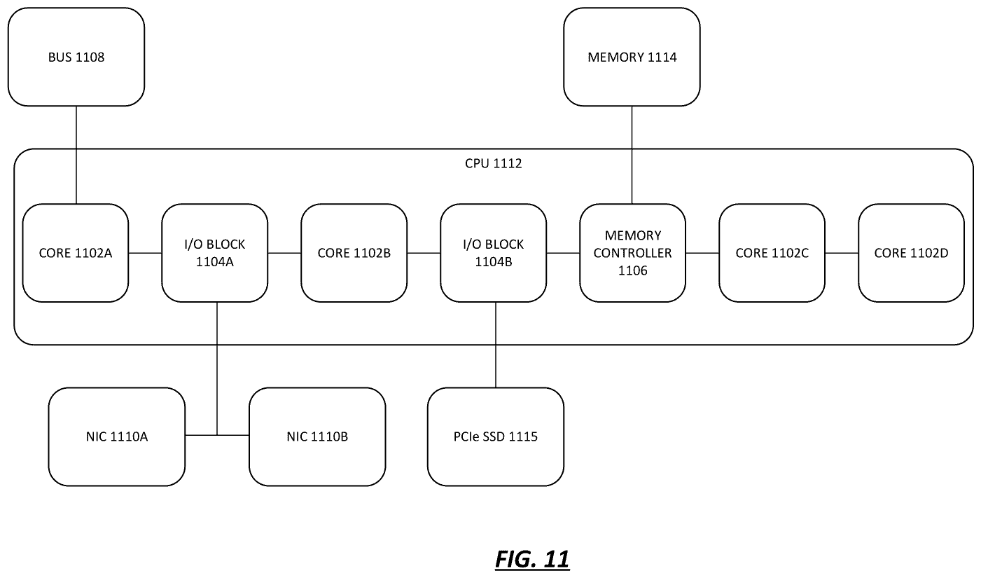

Note that the apparatus', methods', and systems described above may be implemented in any electronic device or system as aforementioned. As a specific illustration, FIG. 11 provides an exemplary implementation of a processing device such as one that may be coupled to locking hardware, such as locking hardware provided in a memory controller device. It should be appreciated that other processor architectures may be provided to implement the functionality and processing of requests by an example host device, including the implementation of the example host devices discussed above. Further, while the examples discussed above focus on the use of CXL and CXL-based protocols, it should be appreciated that reference to CXL is as an illustrative example only. Indeed, the more generalized concepts disclosed herein may be equally and advantageously applied to other interconnects and interconnect protocols that facilitate similar features, among other examples.

Referring to FIG. 11, a block diagram is shown of an example data processor device (e.g., a central processing unit (CPU)) 1112 coupled to various other components of a platform in accordance with certain embodiments, such as those discussed above. Although CPU 1112 depicts a particular configuration, the cores and other components of CPU 1112 may be arranged in any suitable manner. CPU 1112 may comprise any processor or processing device, such as a microprocessor, an embedded processor, a digital signal processor (DSP), a network processor, an application processor, a co-processor, a system on a chip (SOC), or other device to execute code. CPU 1112, in the depicted embodiment, includes four processing elements (cores 1102 in the depicted embodiment), which may include asymmetric processing elements or symmetric processing elements. However, CPU 1112 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 1112, as illustrated in FIG. 11, includes four cores-cores 1102A, 1102B, 1102C, and 1102D, though a CPU may include any suitable number of cores. Here, cores 1102 may be considered symmetric cores. In another embodiment, cores may include one or more out-of-order processor cores or one or more in-order processor cores. However, cores 1102 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 1102 may include a decode module coupled to a fetch unit to decode fetched elements. Fetch logic, in one embodiment, includes individual sequencers associated with thread slots of cores 1102. Usually, a core 1102 is associated with a first ISA, which defines/specifies instructions executable on core 1102. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, as decoders may, in one embodiment, include logic designed or adapted to recognize specific instructions, such as transactional instructions. As a result of the recognition by the decoders, the architecture of core 1102 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 1102, in one embodiment, recognize the same ISA (or a subset thereof). Alternatively, in a heterogeneous core environment, a decoder of one or more cores (e.g., core 1102B) may recognize a second ISA (either a subset of the first ISA or a distinct ISA).

In various embodiments, cores 1102 may also include one or more arithmetic logic units (ALUs), floating point units (FPUs), caches, instruction pipelines, interrupt handling hardware, registers, or other suitable hardware to facilitate the operations of the cores 1102.

Bus 1108 may represent any suitable interconnect coupled to CPU 1112. In one example, bus 1108 may couple CPU 1112 to another CPU of platform logic (e.g., via UPI). I/O blocks 1104 represents interfacing logic to couple I/O devices 1110 and 1115 to cores of CPU 1112. In various embodiments, an I/O block 1104 may include an I/O controller that is integrated onto the same package as cores 1102 or may simply include interfacing logic to couple to an I/O controller that is located off-chip. As one example, I/O blocks 1104 may include PCIe interfacing logic. Similarly, memory controller 1106 represents interfacing logic to couple memory 1114 to cores of CPU 1112. In various embodiments, memory controller 1106 is integrated onto the same package as cores 1102. In alternative embodiments, a memory controller could be located off chip.

As various examples, in the embodiment depicted, core 1102A may have a relatively high bandwidth and lower latency to devices coupled to bus 1108 (e.g., other CPUs 1112) and to NICs 1110, but a relatively low bandwidth and higher latency to memory 1114 or core 1102D. Core 1102B may have relatively high bandwidths and low latency to both NICs 1110 and PCIe solid state drive (SSD) 1115 and moderate bandwidths and latencies to devices coupled to bus 1108 and core 1102D. Core 1102C would have relatively high bandwidths and low latencies to memory 1114 and core 1102D. Finally, core 1102D would have a relatively high bandwidth and low latency to core 1102C, but relatively low bandwidths and high latencies to NICs 1110, core 1102A, and devices coupled to bus 1108.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) devices and other hardware devices. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g., reset, while an updated value potentially includes a low logical value, e.g., set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: one or more interfaces to couple to a first host device and a second host device, where the first host device is to maintain a first coherency domain and the second host device is to maintain a second coherency domain independent of the first coherency domain; one or more storage elements to implement a pending queue and a lock table; and lock management circuitry to: receive a first request from the first host device to lock a portion of shared memory of a memory device, where the first request comprises a first key generated at the first host device; assign a lock to the first host device based on the first request to provide the first host device exclusive access to the portion of the shared memory while the lock is assigned to the first host device, where the lock is recorded in the lock table; receive a second request from the second host device to lock the portion of the shared memory while the lock is assigned to the first host device, where the second request includes a second key generated by the second host device; queue the second request in the pending queue while the lock is assigned to the first host device; and assign the lock to the second host device after the lock is released by the first host device to provide the second host device exclusive access to the portion of the shared memory while the lock is assigned to the second host device.

Example 2 includes the subject matter of example 1, where the lock management circuitry is to perform a lookup of the lock table responsive to receipt of the first request to determine whether a competing lock exists for the portion of the shared memory.

Example 3 includes the subject matter of any one of examples 1-2, where the first host device includes a first driver to communicate with the lock management circuitry and the second host device includes a second driver to communicate with the lock management circuitry, where the first driver is independent of the second driver.

Example 4 includes the subject matter of example 3, where no communication takes place between the first driver and the second driver in association with requests to access the shared memory.

Example 5 includes the subject matter of any one of examples 1-4, where the first host device and the second host device run independent operating systems.

Example 6 includes the subject matter of example 5, where the first request corresponds to an attempt by a first software thread run on the operating system of the first host device to access data in the portion of the shared memory, and the second request corresponds to an attempt by a second software thread run on the operating system of the second host device to access the data.

Example 7 includes the subject matter of any one of examples 1-6, where the first request identifies a first address range in the shared memory, the second request identifies a different second address range in the shared memory, and the portion is included in both the first address range and the second address range of the shared memory.

Example 8 includes the subject matter of any one of examples 1-7, further including a third interface to couple to the memory device.

Example 9 includes the subject matter of any one of examples 1-8, where the lock management circuitry is further to: receive a lock release request from the first host device, where the lock release request includes the first key; determine that the lock release request corresponds to the first request based on the first key; and release the lock based on the lock release request.

Example 10 includes the subject matter of example 9, where the first release request includes a unique identifier, and the lock release request also includes the unique identifier.

Example 11 includes the subject matter of any one of examples 1-10, where the first interface is based on a Compute Express Link (CXL) protocol, and the first request is included in a message based on the CXL protocol.

Example 12 includes the subject matter of example 11, where the memory device includes a CXL-based memory device.

Example 13 is a method including: receiving, at locking hardware of a device, a first request from a first host device to lock a portion of shared memory of a memory device, where the first request includes a key value generated at the first host device for the first request; assigning, in the locking hardware, a first lock to the first host device based on the first request to provide the first host device exclusive access to the portion of the shared memory while the first lock is assigned to the first host device, where the first lock is recorded in a lock table implemented in the locking hardware; receiving, at the locking hardware, a second request from the second host device to lock the portion of the shared memory while the first lock is assigned to the first host device, where the second request includes a key value generated at the second host device for the second request, and the first host device operates independent of the second host device in attempting to access the shared memory; queuing the second request in a pending queue implemented in the locking hardware while the first lock is assigned to the first host device; and assigning, in the locking hardware, a second lock to the second host device after the first lock is released by the first host device to provide the second host device exclusive access to the portion of the shared memory while the second lock is assigned to the second host device.

Example 14 includes the subject matter of example 13, further including facilitating access of the portion of the shared memory by the second host device, while the second lock is assigned to the second host device.

Example 15 includes the subject matter of any one of examples 13-14, further including: receiving, at the locking hardware, a lock release request from the first host device, where the lock release request includes the key value generated at the first host device for the first request; determining that the lock release request corresponds to the first lock as recorded in the lock table of the locking hardware, based at least in part on the key value generated at the first host device for the first request; and releasing the first lock and assigning the second lock based on the lock release request.

Example 16 includes the subject matter of example 15, where the first release request includes a unique identifier, and the lock release request also includes the unique identifier.

Example 17 includes the subject matter of example 16, where the release request further includes a key, and the lock management circuitry is further to check the lock release request for inclusion of the key in the lock release request before the lock is allowed to be released based on the lock release request.

Example 18 includes the subject matter of any one of examples 13-17, where a lock table is implemented in the locking hardware to track active locks assigned to the first host device and the second host device.

Example 19 includes the subject matter of example 18, further including performing a lookup of the lock table responsive to receipt of the first request to determine whether a competing lock exists for the portion of the shared memory.

Example 20 includes the subject matter of any one of examples 13-19, where the first host device and the second host device run independent operating systems.

Example 21 includes the subject matter of example 20, where the first request corresponds to an attempt by a first software thread run on the operating system of the first host device to access data in the portion of the shared memory, and the second request corresponds to an attempt by a second software thread run on the operating system of the second host device to access the data.

Example 22 includes the subject matter of any one of examples 13-21, where the first request identifies a first address range in the shared memory, the second request identifies a different second address range in the shared memory, and the portion is included in both the first address range and the second address range of the shared memory.

Example 23 includes the subject matter of any one of examples 13-22, where the first request is included in a message based on a Compute Express Link (CXL) protocol.

Example 24 includes the subject matter of example 23, where the shared memory is implemented a CXL-based memory device.

Example 25 is a system including means to perform the method of any one of examples 13-24.

Example 26 is a system including: a first host device, where the first host device is to maintain a first coherency domain; a second host device, where the second host device is to maintain a second coherency domain independent of the first coherency domain; a memory device to implement a shared memory; locking hardware coupled to the first host device and the second host device, where the locking hardware is to: receive a first request from a first host device to lock a portion of the shared memory, where the first request includes a first key; assign a first lock to the first host device based on the first request to provide the first host device exclusive access to the portion of the shared memory, where the first lock is recorded in a lock table implemented in the locking hardware; receive a second request from the second host device to lock the portion of the shared memory while the first lock is assigned to the first host device, where the second request includes a second key; hold the second request in a pending queue implemented in the locking hardware while the first lock is assigned to the first host device; and assign a second lock to the second host device responsive to release of the first lock by the first host device to provide the second host device exclusive access to the portion of the shared memory, where the release of the first lock causes the first lock to be removed from the lock table, and the second lock is to be recorded in the lock table.

Example 27 includes the subject matter of example 26, further including a memory controller associated with the memory device, where the memory controller includes the locking hardware.

Example 28 includes the subject matter of example 27, where the memory controller is to allow access by the first host device to the portion of the shared memory based on the first lock and is to block access to the portion of the shared memory by the first host device while the second lock is assigned to the second host device.

Example 29 includes the subject matter of any one of examples 26-28, where the second host device executes a thread associated with the second request and parks the thread while the second request is held in the pending queue.

Example 30 includes the subject matter of example 29, where the thread accesses data from the portion of the shared memory while the second lock is assigned to the second host device.

Example 31 includes the subject matter of any one of examples 16-30, where the locking hardware includes one or more storage elements are to further implement a lock table, and the lock table is to maintain a record of a set of acquired locks to grant exclusive access of respective portions of the shared memory to respective host devices.

Example 32 includes the subject matter of example 31, where the lock management circuitry is to perform a lookup of the lock table responsive to receipt of the first request to determine whether a competing lock exists for the portion of the shared memory.

Example 33 includes the subject matter of any one of examples 16-32, where the first host device and the second host device run independent operating systems.

Example 34 includes the subject matter of example 33, where the first request corresponds to an attempt by a first software thread run on the operating system of the first host device to access data in the portion of the shared memory, and the second request corresponds to an attempt by a second software thread run on the operating system of the second host device to access the data.

Example 35 includes the subject matter of any one of examples 16-34, where the first request identifies a first address range in the shared memory, the second request identifies a different second address range in the shared memory, and the portion is included in both the first address range and the second address range of the shared memory.

Example 36 includes the subject matter of any one of examples 16-35, where the lock management circuitry is further to: receive a lock release request from the first host device; determine that the lock release request corresponds to the first request; and release the lock based on the lock release request.

Example 37 includes the subject matter of example 37, where the first release request includes a unique identifier, and the lock release request also includes the unique identifier.

Example 38 includes the subject matter of example 38, where the release request further includes a key, and the lock management circuitry is further to check the lock release request for inclusion of the key in the lock release request before the lock is allowed to be released based on the lock release request.

Example 39 includes the subject matter of any one of examples 16-38, where the first interface is based on a Compute Express Link (CXL) protocol, and the first request is included in a message based on the CXL protocol.

Example 40 includes the subject matter of example 39, where the memory device includes a CXL-based memory device.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
one or more interfaces to couple to a first host device and a second host device, wherein the first host device is to maintain a first coherency domain and the second host device is to maintain a second coherency domain independent of the first coherency domain;
one or more storage elements to implement a pending queue and a lock table; and
lock management circuitry to:
receive a first request from the first host device to lock a portion of shared memory of a memory device, wherein the first request comprises a first key generated at the first host device;
assign a lock to the first host device based on the first request to provide the first host device exclusive access to the portion of the shared memory while the lock is assigned to the first host device, wherein the lock is to be recorded in the lock table;
receive a second request from the second host device to lock the portion of the shared memory while the lock is assigned to the first host device, wherein the second request comprises a second key generated at the second host device;
queue the second request in the pending queue while the lock is assigned to the first host device; and
assign the lock to the second host device after the lock is released by the first host device to provide the second host device exclusive access to the portion of the shared memory while the lock is assigned to the second host device.

2. The apparatus of claim 1, wherein the lock management circuitry is to perform a lookup of the lock table responsive to receipt of the first request to determine whether a competing lock exists for the portion of the shared memory.

3. The apparatus of claim 1, wherein the first host device comprises a first driver to communicate with the lock management circuitry and the second host device comprises a second driver to communicate with the lock management circuitry, wherein the first driver is independent of the second driver.

4. The apparatus of claim 3, wherein no communication takes place between the first driver and the second driver in association with requests to access the shared memory.

5. The apparatus of claim 1, wherein the first host device and the second host device run independent operating systems.

6. The apparatus of claim 5, wherein the first request corresponds to an attempt by a first software thread run on the operating system of the first host device to access data in the portion of the shared memory, and the second request corresponds to an attempt by a second software thread run on the operating system of the second host device to access the data.

7. The apparatus of claim 1, wherein the first request identifies a first address range in the shared memory, the second request identifies a different second address range in the shared memory, and the portion is included in both the first address range and the second address range of the shared memory.

8. The apparatus of claim 1, further comprising a memory interface to couple to the memory device.

9. The apparatus of claim 1, wherein the lock management circuitry is further to:
receive a lock release request from the first host device, wherein the lock release request comprises the first key;
determine that the lock release request corresponds to the first request based on the first key; and
release the lock based on the lock release request.

10. The apparatus of claim 9, wherein the first release request includes a unique identifier, and the lock release request also includes the unique identifier.

11. The apparatus of claim 1, wherein the one or more interfaces are based on a Compute Express Link (CXL) protocol, and the first request is included in a message based on the CXL protocol.

12. The apparatus of claim 11, wherein the memory device comprises a CXL-based memory device.

13. A method comprising:
receiving, at locking hardware of a device, a first request from a first host device to lock a portion of shared memory of a memory device, wherein the first request comprises a key value generated at the first host device for the first request;
assigning, in the locking hardware, a first lock to the first host device based on the first request to provide the first host device exclusive access to the portion of the shared memory while the first lock is assigned to the first host device, wherein the first lock is recorded in a lock table implemented in the locking hardware;
receiving, at the locking hardware, a second request from the second host device to lock the portion of the shared memory while the first lock is assigned to the first host device, wherein the second request comprises a key value generated at the second host device for the second request, and the first host device operates independent of the second host device in attempting to access the shared memory;
queuing the second request in a pending queue implemented in the locking hardware while the first lock is assigned to the first host device; and
assigning, in the locking hardware, a second lock to the second host device after the first lock is released by the first host device to provide the second host device exclusive access to the portion of the shared memory while the second lock is assigned to the second host device.

14. The method of claim 13, further comprising facilitating access of the portion of the shared memory by the second host device, while the second lock is assigned to the second host device.

15. The method of claim 13, further comprising:
receiving, at the locking hardware, a lock release request from the first host device, wherein the lock release request comprises the key value generated at the first host device for the first request;
determining that the lock release request corresponds to the first lock as recorded in the lock table of the locking hardware, based at least in part on the key value generated at the first host device for the first request; and
releasing the first lock and assigning the second lock based on the lock release request.

16. A system comprising:
a first host device, wherein the first host device is to maintain a first coherency domain;
a second host device, wherein the second host device is to maintain a second coherency domain independent of the first coherency domain;
a memory device to implement a shared memory; and
locking hardware coupled to the first host device and the second host device, wherein the locking hardware is to:
receive a first request from a first host device to lock a portion of the shared memory, wherein the first request comprises a first key;
assign a first lock to the first host device based on the first request to provide the first host device exclusive access to the portion of the shared memory, wherein the first lock is recorded in a lock table implemented in the locking hardware;
receive a second request from the second host device to lock the portion of the shared memory while the first lock is assigned to the first host device, wherein the second request comprises a second key;
hold the second request in a pending queue implemented in the locking hardware while the first lock is assigned to the first host device; and
assign a second lock to the second host device responsive to release of the first lock by the first host device to provide the second host device exclusive access to the portion of the shared memory, wherein the release of the first lock causes the first lock to be removed from the lock table, and the second lock is to be recorded in the lock table.

17. The system of claim 16, further comprising a memory controller associated with the memory device, wherein the memory controller comprises the locking hardware.

18. The system of claim 17, wherein the memory controller is to allow access by the first host device to the portion of the shared memory based on the first lock and is to block access to the portion of the shared memory by the first host device while the second lock is assigned to the second host device.

19. The system of claim 16, wherein the second host device executes a thread associated with the second request and parks the thread while the second request is held in the pending queue.

20. The system of claim 19, wherein the thread accesses data from the portion of the shared memory while the second lock is assigned to the second host device.
